(19) United States
(12) Patent Application Publication
(10) Pub. No.: US 2001/0037290 A1
(43) Pub. Date: Nov. 1, 2001

(54) Method and system for secured web-based escrowed transactions

(76) Inventor: Tony Lai, Bellflower, CA (US)

Correspondence Address: Stephen R. Seccombe, Sheldon & Mak, Suite 503, 290 North "D" Street, San Bernardino, CA, 92401, US

(21) Appl. No.: 09/794,815

(22) Filed: Feb. 26, 2001

Related U.S. Application Data
(60) Provisional application No. 60/184,692, filed on Feb. 24, 2000.
(60) Provisional application No. 60/206,618, filed on May 24, 2000.

(51) Int. Cl. G06F 17/60

(52) U.S. Cl. 705/39

(57) ABSTRACT

A method and system for enabling a secure transaction using the Internet is disclosed. The method comprises using a Personal Identification Number (PIN) for business transactions wherein the customer does not directly reveal financial or home address information during the transaction. Instead, an escrow agent supplies delivery instructions to the merchant. The escrow agent then collects payment from the customer and places the payment in an escrow account. Shipping information is not provided to the merchant until the payment is in escrow. Payment is only made to the merchant after the merchant confirms the goods have been shipped.

### CROSS-REFERENCE TO RELATED APPLICATIONS

This application claims the benefit of Provisional Patent Application Serial No. 60/184,692, filed Feb. 24, 2000, and Ser. No. 60/206,618, filed May 24, 2000, the contents of which are incorporated herein by this reference.

### BACKGROUND

The present invention is directed to network communications involving business transactions and more particularly to communications systems for affecting secured transactions.

The Internet has created opportunities for consumers and merchants to engage in new forms of commerce over this new communications medium. Merchants of every size have established websites where they sell their goods to consumers. These websites combine the immediacy of a storefront with the convenience of catalog shopping by mail. The consumer can enter the store through the use of a Web browser and be treated to an interactive multimedia presentation of the goods offered by the merchant. Purchasing an item is as easy as entering a credit card number and an address. These websites have become phenomenally successful and created large shifts in the spending habits of consumers.

However, this success has not come without a new set of problems created by the very nature of the communications network. The Internet is by design an open and public communications network. Everyone is allowed to access the network and most everyone does because the facilities required to access the network are very inexpensive. This means that both legitimate users and users with a criminal intent can access the system with ease. The Internet is also designed to facilitate easy access to systems communicating across the network. The result is that it is difficult to secure a computer system attached the network from unauthorized entry. Furthermore, since the Internet is a distributed communications network, there are many different processing elements on the network at any moment, and each of these processing elements is known only by its address. Users accessing the Internet are known only by their Internet Protocol (IP) address and a self-chosen host name. Accordingly, users on the Internet are almost anonymous.

These weaknesses in Internet security combine to make a website somewhat vulnerable to attack. A website used as a storefront must collect financial information about a customer to complete a transaction. This information usually includes the name of the customer, a shipping address, and a credit or bank account number which can be debited by the merchant. This information must be stored in a location accessible to the host system. A host system on the net is susceptible to attack because of the open nature of the Internet. Criminals can readily gain access to the Internet and attempt to exploit the features of the open communication protocols. If the host's security systems are breached, then all of the information collected from customers can be stolen from the merchant's database. Breaching a websites security harms both the consumer and the merchant. The consumer loses control of his or her credit card or their bank account and could be held liable for large purchases if the consumer doesn't catch the problem quickly. The merchant is harmed because consumers will eventually learn of the breaches of the merchant's security systems and the merchant's reputation may be diminished. Moreover, the merchant may be responsible for the payment if the consumer and the credit card company both refuse to pay for the fraudulent use of the credit card number.

As noted above, Internet users can remain nearly anonymous. Users do not need to reveal their true identities to access the Internet nor can their true identities be confirmed by the owners of the visited websites. This makes it relatively easy for a criminal to use a stolen credit card or bank account number for an Internet transaction. This aspect of the Internet harms both the consumer and the merchant. This potential for harm may lead the merchant to ask for more information than absolutely necessary from the consumer because the merchant may try to validate the consumer using the merchant's own methods and database. This unnecessary data collection by the merchant trying to protect themselves from fraud may lead consumers to be suspicious of the merchant and cease using the merchant's services.

### SUMMARY

The present invention meets this need by providing a particularly secure and effective system for payments in network transactions. In one aspect of the invention, a system for secured escrowed network transactions between consumers and partners associated with a company, each partner having a partner account, includes a server host computer operatively connected to the communication network; a host database having member tables, partner tables, transaction tables, and bank tables; and means for accessing at least some of the tables of the host database by the server host computer; means for registering consumers as members having respective demographic information, payment accounts, and member identification numbers; means for processing a first network communication from a partner, the first network communication including a member identification number and a transaction amount; means for depositing payment of the transaction amount from the payment account of the member into an escrow account as an escrow deposit; and means for notifying the partner of shipping data for the transaction only following the payment of the transaction amount from the payment account. The means for registering consumers as members can include consumer data entry means accessible through the network for receiving and storing in the host database for each accessing consumer the demographic information, payment account information, and member identification number; means for verifying the demographic information and the payment account information; means for verifying satisfactory credit-worthiness of the payment account; and means for communicating acceptance or denial of the consumer as a member. The means for verifying the demographic information and the payment account information is preferably operable for identifying inconsistent data during a network session in which the data is entered by the consumer.

The system can further include means for processing a second network communication confirming performance by the partner in satisfaction of the transaction amount; and means for withdrawing the transaction amount from the escrow account and depositing the transaction amount into the partner account of the partner only following receipt of the second network communication. The system can also include means for processing a return transaction from the member to the partner, and having means for receiving a third network communication from the partner, the third network communication confirming receipt of returned goods and a return credit amount; and means for transferring a return payment from the partner account to the payment account of the member. The system can include means for linking the member to other members as auxiliary members, the member selectively identifying the other members by respective member identification numbers in combination with an item of demographic information; and wherein the means for notifying the partner of shipping data comprises means for substituting shipping information for an auxiliary member selected by the member. Further, the system can include means for delivery of a grant from the member to the auxiliary member, having means for holding the transaction amount in the escrow account until the auxiliary member communicates acceptance of the grant. Also, the grant can be of a gift certificate, the system further including means for processing a fourth network communication from the partner in response to the auxiliary member selecting of partner performance covered at least in part by the gift certificate; and means for making an offset transfer from the escrow account to the partner account, the offset transfer being in an amount not greater than a value of the gift certificate and not greater than a value of the partner performance.

In another aspect of the invention, a method for secured escrowed network transactions between members having access to consumer computers and a company having partners, includes depositing payment of a transaction amount from a member payment account into an escrow account in response to a first network communication from a partner, the first network communication including a member identification number of the member, and a transaction amount; and notifying the partner of shipping data for the transaction only following payment of the transaction amount into the escrow account. The method can further include transferring the transaction amount from the escrow account into a partner account of the partner only following receipt of a second network communication confirming performance by the partner.

### DRAWINGS

These and other features, aspects, and advantages of the present invention will become better understood with reference to the following description, and accompanying drawings, where:

FIG. 1 is an organizational block diagram of a system for enabling secured network transactions according to the present invention;

FIG. 2 is a screen diagram of a website home page of the system of FIG. 1;

FIG. 3 is a logical diagram of the website of Fig.1;

FIG. 4 is a flowchart of a member sign-up process of the system of FIG. 1;

FIG. 5 is a diagram of a member sign-up page of the system of FIG. 1;

FIG. 6 is a diagram of a partner sign-up page of the system of FIG. 1;

FIG. 7 is a flowchart of a partner registration process of the system of FIG. 1.

FIG. 8 is a Unified Modeling Language (UML) object diagram of initial steps of a transaction using the system of FIG. 1 when a member makes an order using a PIN;

FIG. 9 is a UML object diagram of final steps of the transaction of FIG. 8 when the ordered items are shipped to the member;

FIG. 10 is a UML object diagram of steps that occur in the transaction of FIG. 8 when the member rejects a shipment;

FIG. 11 is a UML sequence diagram of an exemplary use of the system of FIG. 1 to transfer money or a gift certificate from one member to another; and

FIG. 12 is a UML sequence diagram showing redemption of a money transfer or gift certificate in the system of FIG. 1.

### DESCRIPTION

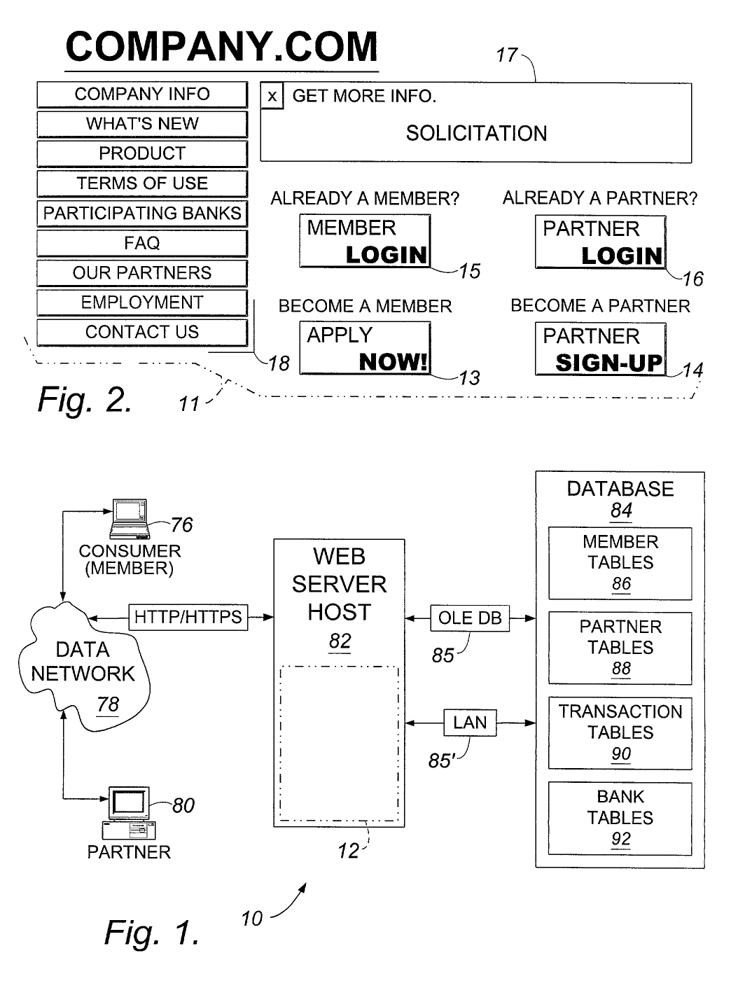

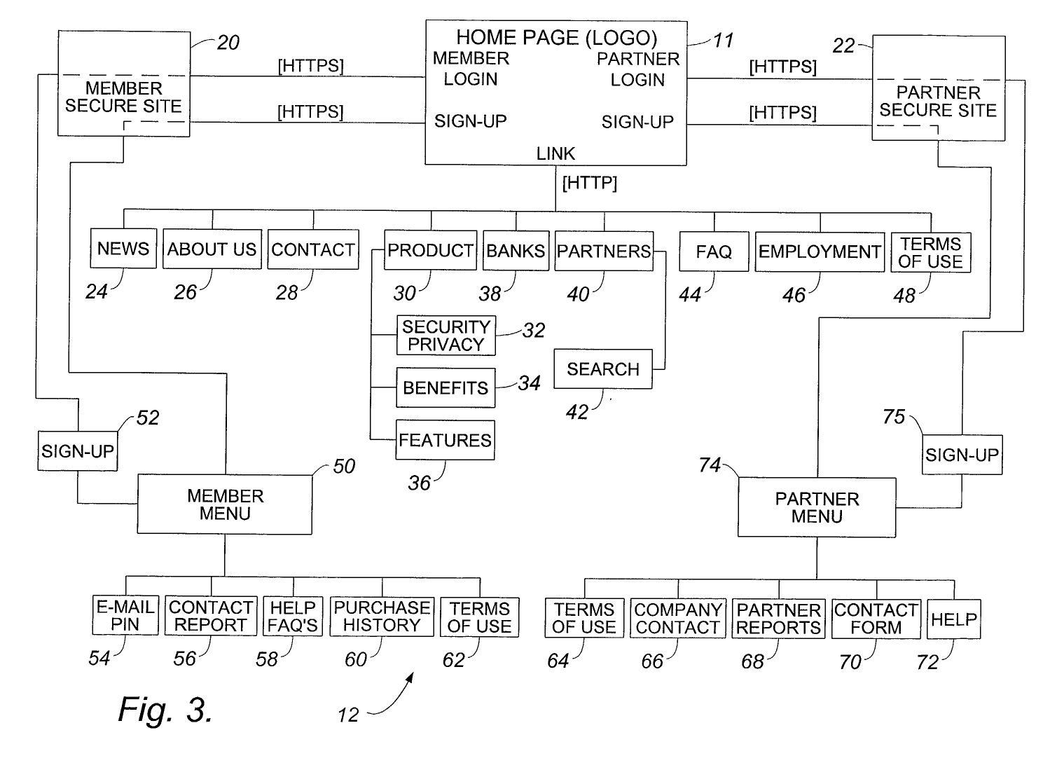

The present invention is directed to a system and method for network-based transactions that is particularly effective in securely handling payments with minimal information required to be revealed by a consumer during the transactions. With reference to FIGS. 1-12 of the drawings, a transaction system 10, a preferred embodiment thereof being diagramed in FIG. 1, is accessed through a home page 11 of a network website 12, the home page having a plurality of user-activated selector buttons including a member sign-up button 13, partner sign-up button 14, member login button 15, and partner login button 16 as shown in FIG. 2. The home page 11 may also include an advertising solicitation 17, and an array of link buttons 18 for accessing specific pages of information about the system 10. As further described below, the login buttons 15 and 16 are links to secure sites, respectively designated member site 20 and partner site 22 in FIG. 3. The network website 12 is also referred to herein as a company website, being managed by an agent of a company or other entity. The company website 12 is accessed in an Internet environment, for example, by a URL of the form “company.com”.

Users, whether or are not members or partners, have public access to information in response to activation of at least some the link buttons 17. More particularly, new events are posted by an authorized agent on a news page 24, information about the agent is on a business page 26, contacting the agent is enabled on a contact page 28, product information is on a product page 30, which has links to a security page 32 having the agent's privacy and security provisions, a benefits page 34 having information explaining product benefits, and a product features page 36. The site also has a banks page 38 containing information on banks participating in the escrow service, a FAQ page 44 having answers to frequently asked questions, an employment page 46 having employment opportunities, and a terms page 48 that explains the terms of use of the system 10. It will be understood that some or all of these pages may contain links to other pages containing additional and/or related information.

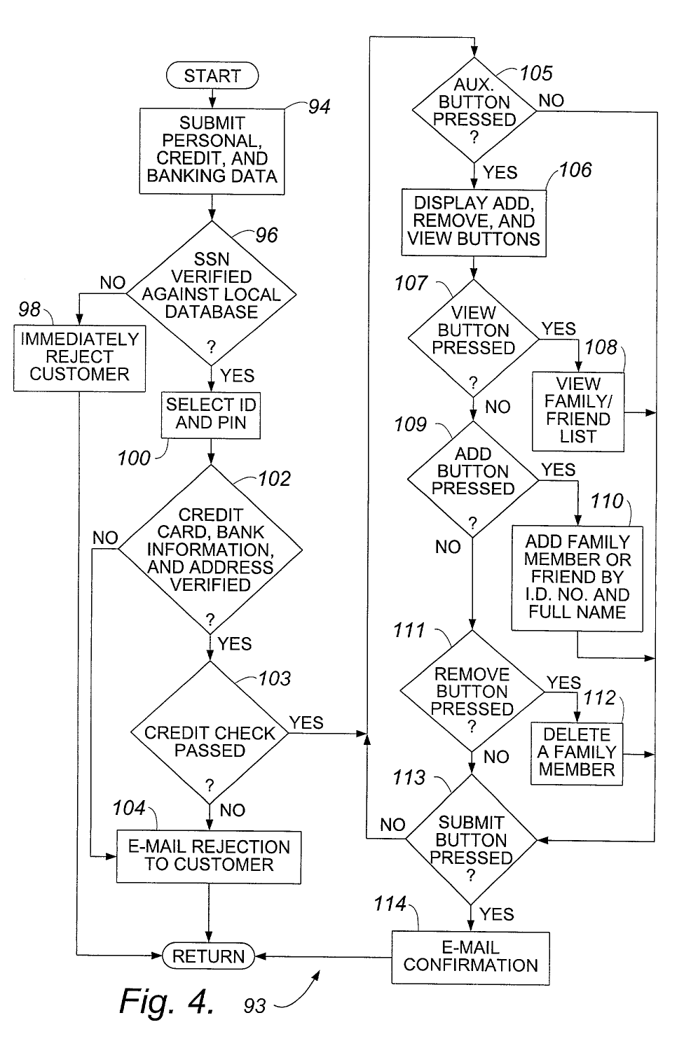

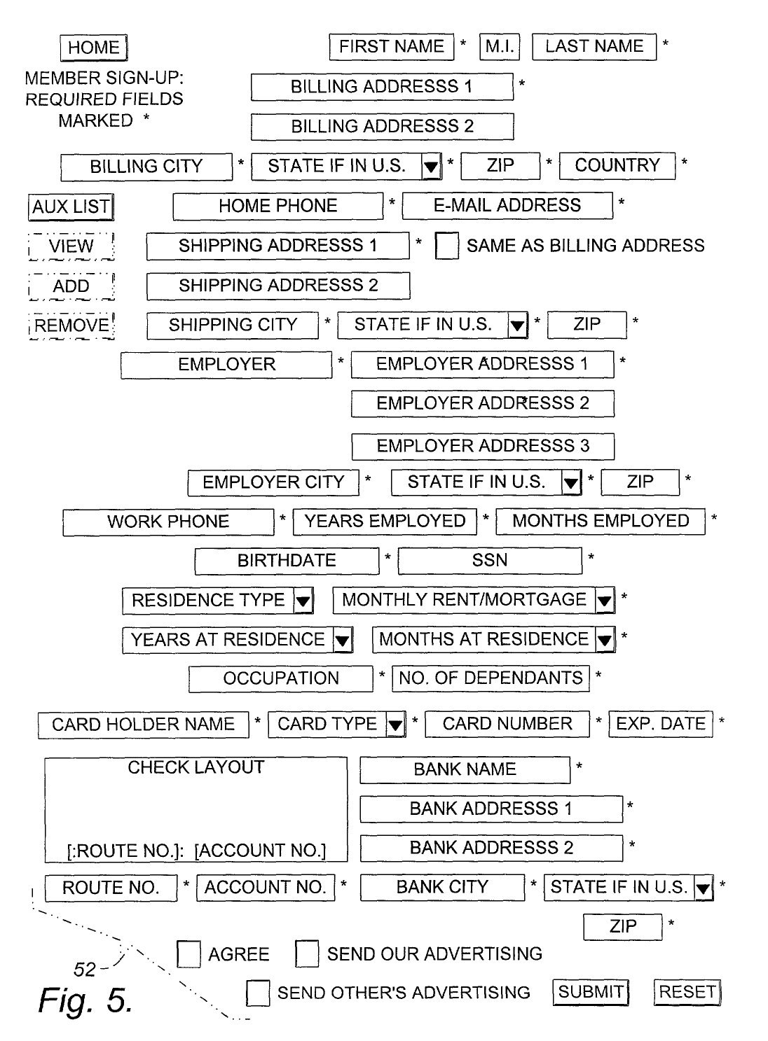

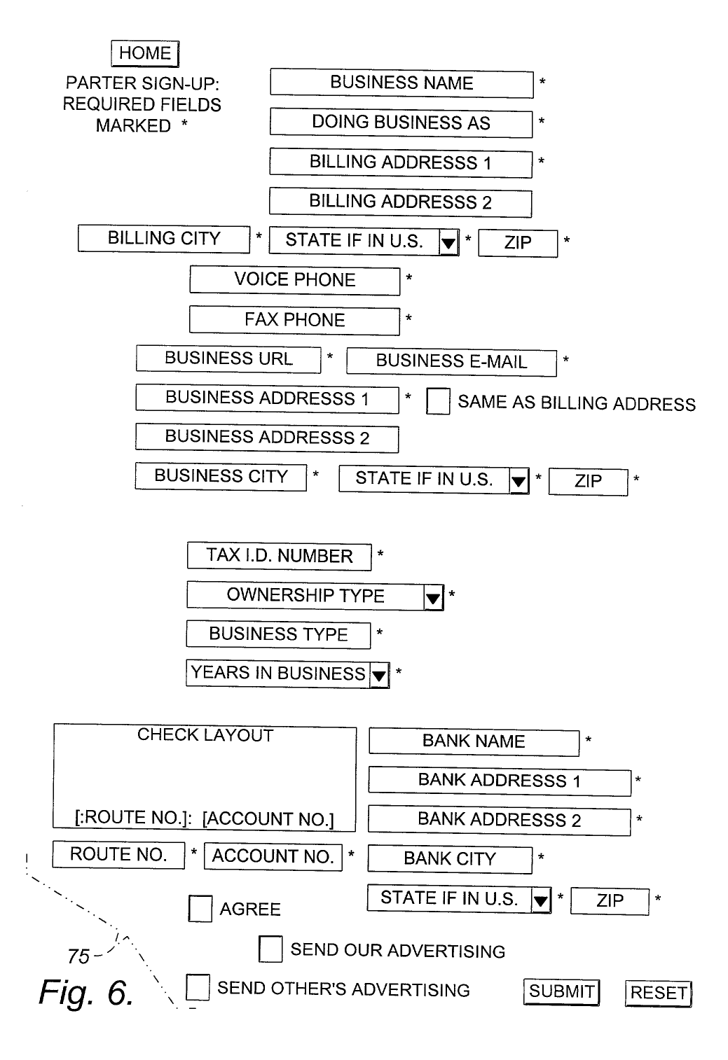

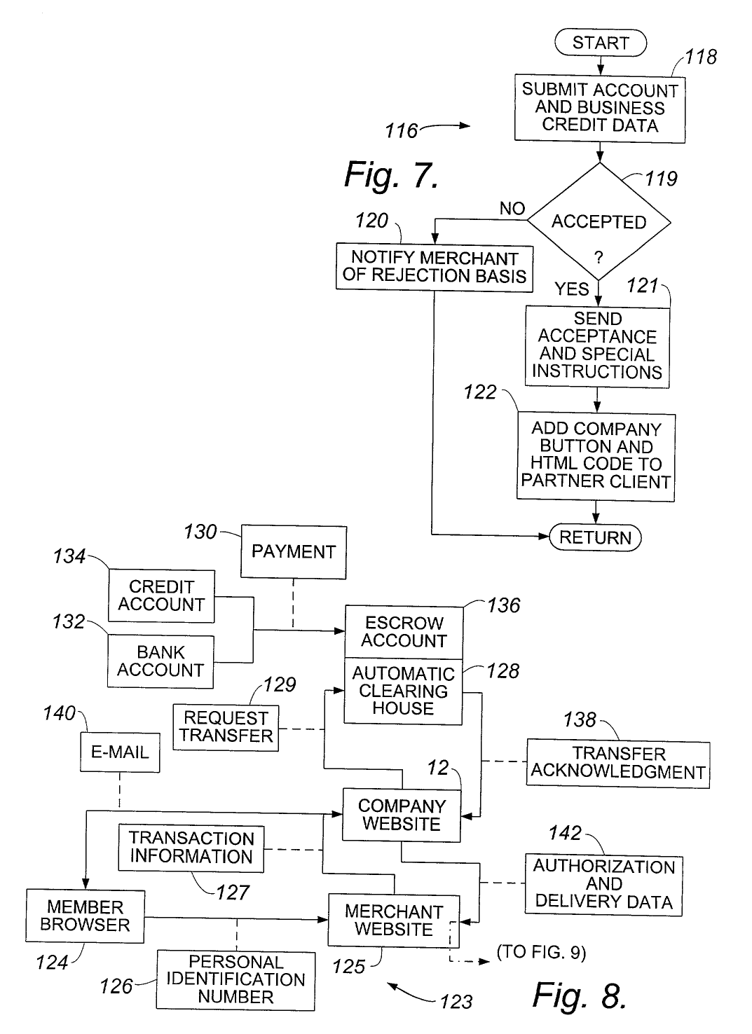

The member secure site 20 includes a member menu page 50 that is entered by clicking on the member login button 15, and a member sign-up page 52 for signing up new members in response to the member sign-up button 13 as described below in connection with FIGS. 4 and 5. Upon completion of sign-up, the member menu page 50 is accessed for selectively accessing an e-mail PIN page 54 for sending members their PINs if the member has forgotten it, an agent contact page 56 for contacting the agent, a member help page 58 that includes answers to frequently asked questions (FAQs), a purchase history page 60, and a member terms page 62 for presenting terms of use by members. The partner secure site 22 includes a counterpart page for terms of use, designated partner terms page 64, a company contact page 66 for contacting other partners or merchants, a partner reports page 68 for reporting on the partner's account activity, an agent contact page 70 for contacting the agent, and a partner help page 72, each of the partner pages being accessed via a partner menu page 74 that is accessed by clicking on the partner login button 16, or by clicking on the partner sign-up button 14 and using a partner sign-up page 75 as described below in connection with FIGS. 6 and 7.

As shown in FIG. 1, member using and being represented by a member computer 76, or a partner using and being represented by a partner computer 80, can access a website's server host 82 of the system 10, via a data network 78 which can be the Internet, using regular or secure hyper-text transport protocol (HTTP/HTTPS). An unregistered user, referred to herein as a “consumer” has limited access the system 10 through either of the computers 76 or 80, or another computer. Accordingly, the member computer 76 is sometimes referred to as a consumer computer, particularly with respect to operations that can be done by unregistered users.

The system 10 also includes a main database 84 that is either remotely or internally hosted and accessed via a local area network (LAN) 85 and/or an object linking/embedding (OLE) path 85′. The database contains data tables and records for members 86, data tables and records for partners 88, tables and records to store transaction data 90, and tables and records to store banking information 92. The member tables 86 include quick logon information, member credit applications, change histories, and account histories of members. The partner tables 88 have corresponding information for partners. The transaction tables 90 include PIN assignments, transaction data for members and partners, company to bank and bank to company transactions, and credit card information. The bank tables 92 include respective company, member, and partner accounts, as well as a transaction account, a general journal, and a funds transmittal log.

A consumer must first register with the agent to become a member of the service. In the preferred embodiment, the consumer accesses the website of the agent to register with the agent. The consumer selects the member sign-up button 13 of the home page 11 FIG. 2, thereby starting a sign-up dialog or process 93 as shown in FIG. 4, the process 93 accessing the member sign-up page 52 via the member secure site as described above in connection with FIG. 3, details of the sign-up page 52 being shown in FIG. 5. The sign-up page 52 is configured as a form to implement the process 93. The consumer fills out the form and submits his name, Social Security Number (SSN), a credit account number or a bank account number, a phone number, an email address, and a mailing address in a personal data input step 94. As shown in FIG. 5, certain of the data entries are indicated as mandatory by an asterisk (*) or other suitable indication, registration being blocked by appropriate means until all of the required data is entered. It will be understood that the agent has discretion in the selection of data requested as well as the portions of which are mandatory. In an alternative embodiment, the user may submit more than one address. The consumer is allowed to link only one bank account or one credit account to each escrow account identified by a Personal Identification Number (PIN).

The consumer's submitted SSN is then compared to a database of valid SSNs, which can reside at the location of the website's server host 82, in a SSN verify step 96. If the SSN is not valid, the customer's request is immediately rejected in a customer reject step 98. If the SSN is valid, the consumer is then allowed to select an identification number (ID) and a PIN in a select step 100. Each ID and PIN is required to be unique across all registered users. The system will verify the ID and PIN and will suggest alternatives if there are conflicts with a previously registered consumer.

The consumer's credit card account and/or bank account and address are verified in a bank verify step 102, which is followed by a credit verify step 103. It will be understood that steps 102 and 103 can be combined, or distinct as shown in FIG. 4, step 102 being directed to verification that the information supplied by the customer is valid. Step 103 is directed to a determination of the availability of credit, and/or the condition of the customer's bank account. This process may be done after the consumer has left the website. Also, successful registration may be conditioned by the agent on satisfactory results on either or both of credit card and bank accounts. Address verification can be done in various ways, including comparison by the system 10 of the submitted address with addresses listed for the consumer in the consumer's credit report; by emailing the consumer and requesting electronic verification; and by calling the consumer and verifying the address. If the consumer's address cannot be verified, the consumer's application is rejected and the consumer is notified by email in an e-mail rejection step 104. Preferably, at least the bank verify step 102 is performed during the time that the consumer computer 76 remains in communication with the member sign-up page 52. Subscription services for performing this function at a location remote from the server host 82 are commercially available from credit reporting agencies such as Equifax, of ______, ______. It is contemplated that the server host 82 will be implemented for providing operator intervention in case of non-matching data, for facilitating the correction of data entry mistakes of the consumer. The consumer is notified by email in a confirmation step 114 if the consumer's application is accepted.

The confirmation step 114 is not performed until the consumer has had opportunity to select additional options and review the application for correctness. Thus, upon an affirmative result in the credit verify step 103, control is passed to a test auxiliary button step 105 for polling the exercise of these options. As shown in FIG. 5, there are conventionally implemented “HOME”, “SUBMIT”, and “RESET” buttons on the sign-up page 52. Also, there are boxes to check for requesting advertising of the entity represented by the system 10 and other business entities, as well as for affirming agreement to membership terms (a suitable link (not shown) being provided for viewing such terms. Moreover, a member can order a transaction for the benefit of another as further described below.

As further shown in FIG. 5, a registering consumer may add a family member or friend to a Family/Friend List if the family member or friend is already registered with the agent and the registered member knows the member identifiers of the registered family member or friend. The purpose of the Family/Friend List is to provide links to additional addresses to which on-line purchases can be sent. Alternatively, the Family/Friend List can be used to send reminders to the registered member of a family member's or friend's upcoming birthday. More particularly, a “Family/Friend List” option is presented to the registering consumer by placment of a corresponding selection button, labeled “AUX LIST” in the member sign-up page 52. Selecting the AUX LIST button following the affirmative completion of the credit verify step 103 causes the test auxiliary button step 105 to pass control to a show option buttons step 106, which displays additional buttons on the sign-up page 52 as indicated by dotted lines showing a “VIEW” button, an “ADD” button, and a “REMOVE” button in FIG. 5. It will be understood that these temporarily hidden buttons can be shown continuously, if desired. On the other hand, the AUX LIST button itself can be hidden until successful completion of the credit verify step 103.

Following the show option buttons step 106, a test view button step 107 interrogates the VIEW button, and if pressed control is passed to a view auxiliary list step 108 to show other members (if any) that were previously linked by the particular member. If the VIEW button had not been pressed, the ADD button is interrogated in a test add button step 109; if pressed, a dialog is presented for entry of the identification number and the full name of an additional member by the registering consumer. If there is a match, the name and address of the linked member is added to the auxiliary list for display upon a subsequent activation of the VIEW button by the selecting member, thereby allowing the registering consumer to add an address of a family member or friend to the list of addresses to which a purchase can be shipped. The auxiliary list for each member is maintained at the server host 82 and entered into the main database 84. Similarly, following a negative result from the test add button step 109, election of the REMOVE button is determined in a test remove button step 111, in which case a suitable dialog is presented for the registering consumer to delete in a delete linked member step 112 selected names or addresses from the auxiliary list of family and friends. If the REMOVE button had not been pressed, or following completion of the view step 108, the add step 110, or the delete step 112, or if there was a negative result from the test auxiliary button step 105, control is passed to the confirmation step 114, the member sign-up process being thus completed.

Preferably, once a member account has been established, the member may not change the account data without the agent's verification. Verification is obtained by contacting the member by telephone, by email messages sent to the original email address, by using the postal service. Alternatively, members may gain access to their accounts using a password, or after satisfying a zero-knowledge identification algorithm using a public private key encryption method, many of which are well known to practitioners of the art of computer science.

A merchant must register with the agent to become a partner. In the preferred embodiment, the merchant accesses the server host 82 as described above by the home page 11 of the company website 12 to register with the agent. The merchant selects the partner sign-up button 14 in FIG. 2 and accesses the partner sign-up page 75 shown in FIG. 6. FIG. 7 is a simplified flowchart of a partner sign-up process 116 for registering the merchant as a partner, in a manner corresponding to the above-described member sign-up process 93. The merchant fills out the form, submitting his name and business credit information in an merchant data entry step 118. The credit worthiness of the merchant is determined in a merchant test step 119. The merchant is notified if rejected in a merchant reject step 120, or if accepted as a partner, the partner is notified and given instructions on how to use the escrow services in a partner confirmation step 121. The partner then adds a button to the partner's website in an add company button step 122, thereby allowing a member to select the company agent as the conduit for payment in a transaction of the member with the partner.

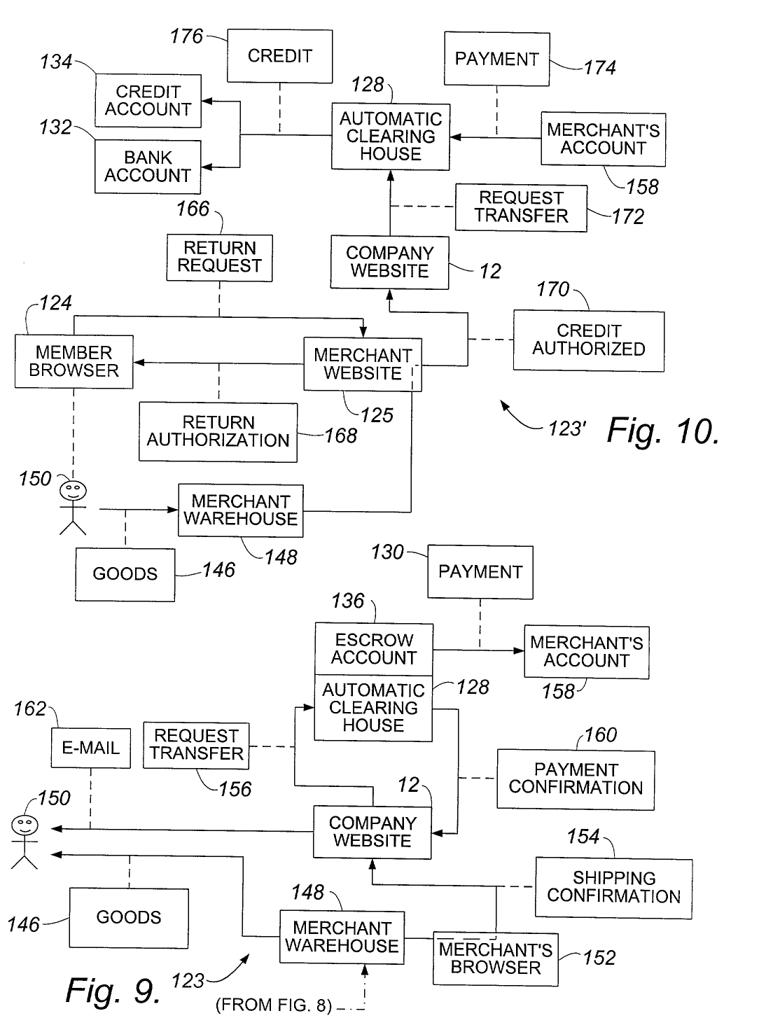

FIGS. 8 and 9 diagram a network transaction process 123 using the system 10, the network typically being the Internet. FIG. 8 shows an order placement portion of the process, FIG. 9 showing completion of the transaction. In the preferred embodiment, the member uses a member browser 124 to access a partner's merchant website 125 by way of the Internet. The consumer selects an item from the merchant website and clicks on the company button option to select payment using the services of the company agent. The consumer then submits his PIN 126 to the merchant website 125. It is a notable feature of the initial transaction that the member does not submit any address or personal information to the merchant. The merchant website 125 then forwards transaction information 127 including the PIN 126 and the amount of the transaction (and the partnership identity of the merchant) to the agent's company website 12. The company website 12 then validates the transaction by confirming that the merchant is a valid partner and that the submitted PIN is the number of a valid member. The agent's website then contacts an Automatic Clearing House (ACH), designated clearing house 128, sending a transfer request 129 for making an escrow payment 130 from the member's bank account 132 or credit account 134 to an escrow account 136 that is maintained by the clearing house 128. Alternatively, the escrow account 136 is maintained with the bank holding the member's bank account 132 or credit account 134, or by the company agent. The clearing house 128 then sends a transfer acknowledgment 138 to the agent as represented by the company website 12. The agent can notify the member of the escrow payment 130 by any suitable means, such as by an e-mail message 140 from the company website 12 to the consumer's member computer 76 as represented in FIG. 8 by the member browser 124, the message 140 confirming that an escrow payment has been made to the escrow account 136. If the transaction is validated, the agent's company website 12 sends an authorization 142 giving an authorization number and the member's address to the merchant website 125. The merchant then begins to process the order. One half the transaction process 123 is now completed and the payment for the goods purchased from the merchant is now held in escrow by the agent in an escrow account 136.

As shown in FIG. 9, the transaction process 123 is completed by the merchant first shipping the goods 146 from his warehouse, designated merchant warehouse 148, to the member, indicated by the FIG. 150. The merchant then uses a browser 152 to access the agent's company website 12, sending a shipping confirmation 154 to confirm that the shipment was made. The agent, as represented by the company website 12, then sends a transfer request 156 to the clearing house 128 for transfer of the payment 130 previously placed in the escrow account 136 to the merchant's merchant account 158. Optionally, the clearing house 128 sends a payment confirmation 160 to the agent as represented by the company website 12, from which an email confirmation 162 is sent to the member confirming that the goods have been shiped and/or that the merchant has been paid. Alternatively, delivery of the goods can be confirmed by a shipper, so that the merchant account is not credited until the member 150 has received the goods. Also, a counterpart of the e-mail confirmation 160 relating to shipment can be sent to the member 150 immediately upon receipt of the shipping confirmation 154 by the company website 12, or directly by the merchant.

With particular reference to FIG. 10, a further aspect of the network transaction process, designated return process 123′, is manifested when a member returns the goods 146 to the merchant. The member 150 contacts the merchant's website using the member browser 124. The member makes a return request 166 which is honored by the merchant sending a return authorization 168 to the member 150, such as by e-mail. When the member returns the goods 146 to the merchant warehouse 148, the merchant,as represented by the merchant website 125, sends a credit authorization 170 to the agent's company website 12. The agent, as represented by the website 12, sends a transfer request 172 to the clearing house 128. The clearing house 128 then transfers a return payment 174 from the merchant's account 158 as a return credit 176 directly to the account used by member to purchase the goods, being the member bank account 132 or the member credit account 134.

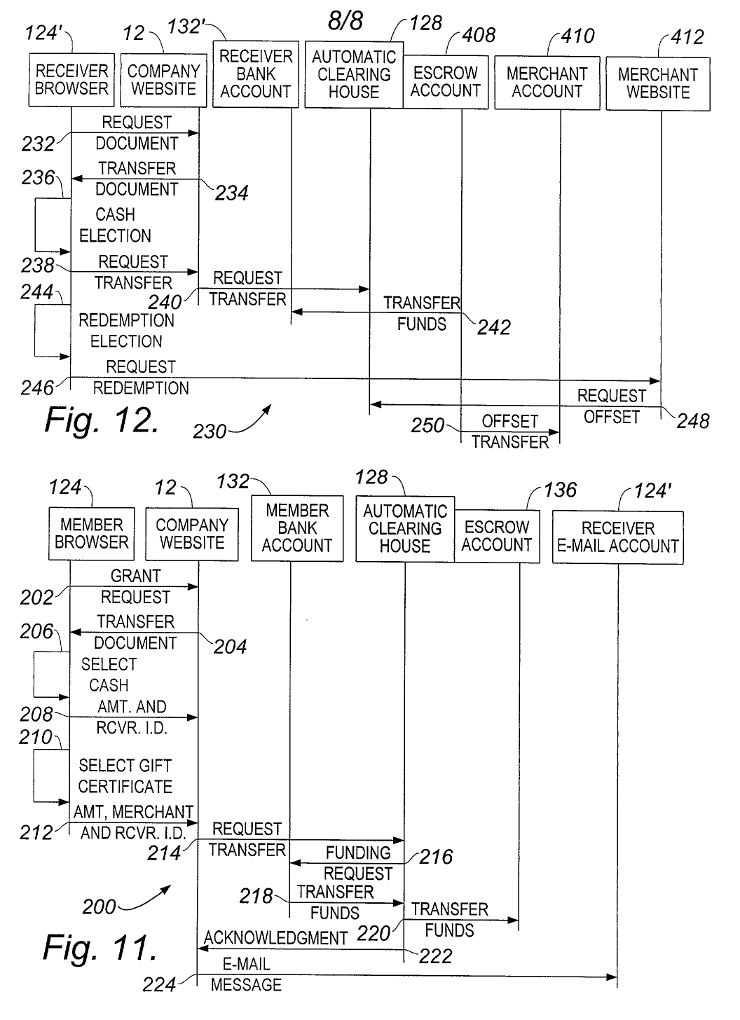

With particular reference to FIG. 11, a grant sequence 200 illustrates how cash transfers and gift certificates can be exchanged between member accounts using the system 10 of the present invention. A member using the member browser 124 requests a gift certificate or cash transfer order document by sending a grant request 202 to the agent's company website 12. The Agent's company website 12 transmits the gift certificate or cash transfer order document in a document transfer 204 to the member browser 124. The member then selects from available options whether the transaction is to be a cash transfer, gift certificate, or other type of grant. Upon a cash transfer selection 206, the member provides receiver cash data 208 including the cash amount and the receiver's member identifier to the agent's company website 12. If instead the member makes a gift certificate selection 210, the member provides member certificate data 212 including the amount, a merchant identifier, and the receiver's member identifier, to the agent's company website 12. For both cash transfers and gift certificates, a request is sent as a transfer request 214 from the company website 12 to the automatic clearing house 128 which in turn sends a funding request 216 to the member bank account 132 for the required amount. The bank then makes a funds transfer 218 from the member bank account 132 to the clearing house 128, which transfers the funds as an escrow deposit 220 into the escrow account 136, where the funds are held until the receiving member either transfers the cash transfer to the receiving member's account or redeems the gift certificate as described below. It will be understood that the selection of grant type (cash, gift certificate, etc., optionally including the receiver cash data 208 or the certificate data 212, can alternatively or additionally be provided for in the initial grant request 202 made by the member. Further, the grant can be made in the alternative, so that the receiving member has the option for redeeming the grant in more than one form. When this is done, the face amount of a gift certificate may be made greater than the amount of a cash grant, in which case it is contemplated that a partial refund would be made to the member bank account 132 in the event that the receiving member elects to receive cash. Once the escrow deposit 220 is complete, a grant acknowledgment 222 is sent from the clearing house 128 to the agent's company website 12, which in turn sends a grant notification 224 to the recipient member by suitable means as an e-mail message. The grant notification 224 informs the receiving member that the cash transfer or gift certificate is ready for redemption.

With particular reference to FIG. 12, a redemption sequence 230, for the amount of the cash transfer or gift certificate obtained in the grant sequence 200 of FIG. 11, commences following receipt of the grant notification 224. The receiving member uses an available receiver browser 124′, being a counterpart of the member browser 124, to access the agent's company website 12 with a document request 232, which can be in the form of an e-mail reply if the grant notification 224 is an e-mail message. A document transfer 234 is sent from the company website 12 to the receiver browser 124′ offering a selection to the receiving member to receive the grant. The selection, for example, could be for the cash transfer to be made to a receiver bank account 132′ being a counterpart of the member bank account 132, or in another form such as a credit to a counterpart of the member credit account 134. In the case of a gift certificate, the receiving member might elect whether the certificate is to be electronically transmitted graphically or as text, by mailing of hard-copy, and/or the destination of the transmission. Further, as indicated above, the receiving member may be given a choice of cash or the gift certificate. As shown in FIG. 12, following a cash election 236 of the receiving member, a recipient transfer request 238 is sent from the receiver browser 124′ to the company website 12, a counterpart of the request, designated escrow transfer request 240, being forwarded to the automatic clearing house 128. The clearing house 128 withdraws funds from the escrow account 136 in a cash deposit 242 to the receiver bank account 132′, thus completing a cash transfer from the granting member to the receiving member. If the receiving member is eligible to and makes a certificate redemption election 244, a redemption request 246 is sent from the receiver browser 124′ when the receiving member is paying for a purchase from a merchant, the redemption request 246 being forwarded as an offset request 248 from the merchant website 125 to the clearing house 128 (which forwarding may be via the company website 12). Finally, the automatic clearing house 128 makes an offset transfer 250 from the escrow account 136 to the merchant account 158 in the amount of the gift certificate. If the amount of the gift certificate is greater than the amount of the receiving member's purchase, only the amount of the purchase is transferred from escrow account 136.

Thus the system 10 of the present invention provides secure transactions between customers and merchants or other vendors, without requiring the customers to provide detailed demographic information to the merchants, and the merchants are not burdened with shipping details until funds for the transactions are deposited in escrow. The system further provides secure and orderly return of goods, as well as escrowed cash and gift certificate grants between participating parties. Security is provided by the escrow account, controlled by a third party, for the holding of funds until the transaction is completed. The limitation of the amount of information revealed by the consumer during an Internet transaction is also advantageous, facilitating order placement by members. The shipping address, if needed, is revealed to the merchant after payment is made into an escrow account. The system 10 of the present invention increases consumer confidence in the use of the Internet for purchasing goods. A consumer's lack of confidence in the Internet often derives from having to give a merchant the consumer's credit card number or bank account number, which is stored on the merchant's not completely secure website host. The system 10 circumvents the need to leave the consumer's credit card or bank information in vulnerable sites all over the network. The actual credit information is stored at only one site, the escrow agent's site. The only information left with a merchant is the consumer's PIN which can only be used by a merchant known to the escrow agent. The consumer is protected from criminals taking the PIN from a merchant because an authorized merchant will only ship goods to the addresses known by the escrow agent. The consumer is further protected from the possible occurrence of an unscrupulous or careless merchant because the escrow agent notifies the consumer whenever an escrow payment is made and the payment is held in escrow until the goods are shipped or delivered. This gives the consumer an opportunity to challenge the escrow payment to the merchant and to notify the escrow agent that a merchant has behaved in an unauthorized manner. The escrow agent can remove the noncompliant merchant from the list of registered merchants. The system 10 of this invention also increases merchant confidence in the use of the Internet for selling goods, by allowing payment to the merchant before the merchant begins the fulfillment of the consumer's order.

Although the present invention has been described in considerable detail with reference to certain preferred versions thereof, other versions are possible. Therefore, the spirit and scope of the appended claims should not necessarily be limited to the description of the preferred versions contained herein.

What is claimed is:

1. A system for secured escrowed network transactions between consumers having access to consumer computers and a company having partners, each partner having a partner account and access to a partner computer, the consumer and partner computers each being connectable to a communication network, the system comprising:
(a) a server host computer operatively connected to the communication network;
(b) a host database having member tables, partner tables, transaction tables, and bank tables; and
(c) means for accessing at least some of the tables of the host database by the server host computer;
(d) means for registering consumers as members having respective demographic information, payment accounts, and member identification numbers;
(e) means for processing a first network communication from a partner, the first network communication including a member identification number and a transaction amount;
(f) means for depositing payment of the transaction amount from the payment account of the member into an escrow account as an escrow deposit; and
(g) means for notifying the partner of shipping data for the transaction only following the payment of the transaction amount from the payment account.

2. The system of claim 1, wherein the means for registering consumers as members comprises:
(a) consumer data entry means accessible through the network for receiving and storing in the host database for each accessing consumer the demographic information, payment account information, and member identification number;
(b) means for verifying the demographic information and the payment account information;
(c) means for verifying satisfactory credit-worthiness of the payment account; and
(d) means for communicating acceptance or denial of the consumer as a member.

3. The system of claim 2, wherein the means for verifying the demographic information and the payment account information is operable for identifying inconsistent data during a network session in which the data is entered by the consumer.

4. The system of claim 1, further comprising:
(a) means for processing a second network communication confirming performance by the partner in satisfaction of the transaction amount; and
(b) means for withdrawing the transaction amount from the escrow account and depositing the transaction amount into the partner account of the partner only following receipt of the second network communication.

5. The system of claim 4, further comprising means for processing a return transaction from the member to the partner, comprising:
(a) means for receiving a third network communication from the partner, the third network communication confirming receipt of returned goods and a return credit amount; and
(b) means for transferring a return payment from the partner account to the payment account of the member.

6. The system of claim 4, further comprising:
(a) means for linking the member to other members as auxiliary members, the member selectively identifying the other members by respective member identification numbers in combination with an item of demographic information; and
(b) wherein the means for notifying the partner of shipping data comprises means for substituting shipping information for an auxiliary member selected by the member.

7. The system of claim 6, further comprising means for delivery of a grant from the member to the auxiliary member, comprising means for holding the transaction amount in the escrow account until the auxiliary member communicates acceptance of the grant.

8. The system of claim 7, wherein the grant is of a gift certificate, the system further comprising:
(a) means for processing a fourth network communication from the partner in response to the auxiliary member selecting of partner performance covered at least in part by the gift certificate; and
(b) means for making an offset transfer from the escrow account to the partner account, the offset transfer being in an amount not greater than a value of the gift certificate and not greater than a value of the partner performance.

9. A method for secured escrowed network transactions between members having access to consumer computers and a company having partners, the method comprising:
(a) depositing payment of a transaction amount from a member payment account into an escrow account in response to a first network communication from a partner, the first network communication including a member identification number of the member, and a transaction amount; and
(b) notifying the partner of shipping data for the transaction only following payment of the transaction amount into the escrow account.

10. The method of claim 9, further comprising transferring the transaction amount from the escrow account into a partner account of the partner only following receipt of a second network communication confirming performance by the partner.
